(19) United States
(12) Patent Application Publication
(10) Pub. No.: US 2012/0193840 A1
(43) Pub. Date: Aug. 2, 2012

(54) METHOD OF MANUFACTURING SOLID SOLUTION PERFORATOR PATCHES

(75) Inventor: Sung-Yun Kwon, Fremont, CA (US)

(73) Assignee: THERAJECT, INC.

(21) Appl. No.: 13/364,438

(22) Filed: Feb. 2, 2012

Related U.S. Application Data
(60) Provisional application No. 61/438,690, filed on Feb. 2, 2011.

(51) Int. Cl. B29C 33/40; B29C 37/00; B29C 51/10

(52) U.S. Cl. 264/571; 264/220; 264/154

(57) ABSTRACT

Provided are methods for fabricating and manufacturing solid solution perforators (SSPs) using sharp metal and subsequent molding and use. The methods entail making microneedles by precision machining techniques and micromold structures from plastic materials. Various designs of patch are described.

### BACKGROUND OF THE INVENTION

The present invention disclosed herein relates to a method of manufacturing solid solution perforator patches, and more particularly, to a method for automatic fabricating and manufacturing solid solution perforators (SSPs) such as dissolving microneedles and SSP patch using continuous process.

Transdermal and intradermal delivery of drugs including protein and vaccine delivery, is a very effective method for achieving systemic or vaccination effects. However, there are barriers involved in providing sufficient drug penetration across the skin. Skin consists of multiple layers. The stratum corneum is the outermost layer, then there is a viable epidermal layer, and finally a dermal tissue layer. The thin layer of stratum corneum of 10-50 μm represents a major barrier for drug delivery through the skin. The stratum corneum is responsible for 50%-90% of the skin barrier property against transdermal drug delivery, depending upon the physical and chemical properties of the drug material, in particular, lipophilicity and molecular weight.

The use of microneedles in transdermal and intradermal delivery is advantageous as intracutaneous drug delivery or drug sampling can be accomplished by reducing the above barrier without pain and bleeding. As used herein, the term “microneedles” refers to a plurality of elongated structures that are sufficiently long to penetrate through the stratum corneum skin layer into the epidermal or dermal or subcutaneous layer. In general, the microneedles are not so long as to penetrate into the dermal layer, although there are circumstances where penetrating the dermal layer would be necessary or desirable. The use of microneedles as an alternative to the use of hypodermic needles for drug delivery by injection is disclosed in U.S. Pat. No. 3,964,482, in which an array of either solid or hollow microneedles is used to penetrate through the stratum corneum and into the epidermal layer. Fluid is dispensed either through the hollow microneedles or through permeable solid projections, or perhaps around non-permeable solid projections that are surrounded by a permeable material or an aperture. A membrane material is used to control the rate of drug release, and the drug transfer mechanism is absorption.

Other types of microneedle and microblade structures are disclosed in PCT Publications Nos. WO 98/00193, WO 97/48440, WO 97/48441, WO 97/48442 and WO 96/37256. Microneedles (less than 1 mm in diameter) have been used to effect percutaneous drug delivery. Microneedles have also been used to deliver a drug through a lumen in the needles, to deliver a drug along the outside of the needle shafts, or as skin perforators for subsequent patch drug application. Silicon microneedles, for example, have been developed using the microfabrication method or Microelectromechanical Systems (MEMS) fabrication method. Examples are described in U.S. Pat. Nos. 6,334,856, 6,256,533, 6,312,612 and 6,379,324. Unfortunately, silicon needles are not dissolvable in the skin, can break during use and stay in the skin tissue, producing considerable irritation and even infection. Non-silicon microneedles have also been developed. Examples are described in U.S. Pat. Nos. 6,334,856 and 6,091,975. However, microneedles that are made of metal or plastic are insoluble or slowly dissolve (i.e., in less than several hours) in the skin, and are therefore generally used for providing a microconduit to transport drug from a drug reservoir, or for creating micropores. Typical way to load the drug is coating on the metal or plastic, which is hard to control and the loading amount is restricted.

Microneedles may be fabricated by the MEMS fabrication method, which is disclosed in U.S. Pat. Nos. 6,663,820 and 6,334,856 in which the positive matter of microneedles is fabricated by using MEMS technology. However, MEMS fabrication for the master microneedle array can be expensive and complicated. Moreover, the polymeric microneedles may require drug loading or drug coating, rendering the casting methods unsuitable for mass production.

### SUMMARY OF THE INVENTION

The present invention overcomes complicated fabrication problems and provides inexpensive and uncomplicated methods for manufacturing SSP drug delivery systems including dissolvable microneedles. Additionally the invention provides a method for mass production constructing microneedle patches.

The microneedles for use in the present invention are made by making a mold from a metal. For constructing a positive master mold is by precision machining, such as Computer Numerical Control (CNC) milling, grinding or drilling. See, e.g., CNC Machining Handbook, James Madison, Industrial Press, Inc., 1991; and An Introduction to CNC Machining and Programming, Gibbs and Crandell, Industrial Press, Inc. 1996, for a discussion of CNC methods. For example, from a block or cylinder of steel, two trench arrays can be cut in two perpendicular directions with predetermined side-wall angles and an array of pyramid shaped microneedles can be generated with desired side angles. From this metal pyramid master microneedle can make negative plastic mold like polyethylene, polypropylene, PET and silicone continuously. (FIG. 1)

From the flexible plastic “negative mold” herein, can be made and used for continuous fabricating dissolvable SSPs. The dissolvable system includes a solid matrix of dissolvable (including meltable) material that optionally holds one or more selected drugs and is formed into one or more perforators from the negative mold. The matrix can be composed of fast-dissolving and/or swelling materials. The solid solution can be a homogeneous, non-homogeneous, suspension solution with a different drug loading phase. In order to make the dissolving SSPs, a positive master prototype is first manufactured with the methods described above. A negative mold of inert plastic film is then fabricated by squeezing from the above positive metal master. In particular, the secondary plastic negative mold fabrication allows cost-effective mass production and utilizes the inherent properties of plastic materials, such as low surface energy, flexibility, gas-permeation, and the like. In another embodiment, the plastic negative mold is not separated from the microneedle array until the microneedle array is used. In this embodiment, the inexpensive mold is used as packaging material to keep the microneedle array intact. Making the microneedle cavity in the negative mold open end at the cavity bottom corner is to easily fill the cavity with gel by applying a vacuum through the hole or even by pressing gel into the cavity. This feature can make the mass production cost effectively.

The SSP microneedle array including drug is fabricated by casting a drug-containing hydrogel or like moldable material in the negative plastic mold. Various micro solid solution array can be prepared by multiple process. For example the drug can be concentrated into the microneedle tip by above filling method or centrifuging process, such as described in PCT Publication No. WO 07/030,477, incorporated herein by reference in its entirety. By “microneedle tip” is meant the tapered end of the microneedle. An adhesive layer can be cast between microneedles by a multiple casting/wiping process of the drug gel and adhesive layer for making the sticky basal layer. A flexible layer can be laminated over the sticky layer. The final microneedle will be a flexible and a self-sticky microneedle array.

Another method for penetrating effectively into the skin is to increase the mechanical strength of the microneedles by a formulating and post-drying process of the microneedle. In particular, by adding a mono- or di-saccharide to the matrix polymer, carboxymethyl cellulose, the mechanical strength can be improved. In addition, use of a post-drying process (or removing additional water content from the microneedle matrix) after separating from the mold improves the mechanical strength of the microneedle.

Accordingly, in one embodiment, the invention is directed to a method of manufacturing a microneedle array comprising (a) preparing a positive master mold by machine cutting microneedles in a plate or cylinder preferably cylinder, wherein the microneedles are cut at a predetermined distance from one another, and further wherein the microneedle tips protrude from the bottom of the defining plate or cylinder surface; (b) preparing a negative mold by either squeezing a castable plastic material onto the positive master mold or forcing the positive master mold into a material, to produce a negative mold having the same surface contour as the positive master mold with open tip; (c) placing and applying force (pressure or vacuum from bottom) a dissolvable API hydrogel to the negative mold to form a dissolvable microneedle array; and (d) drying the microneedle array.

In certain embodiments, the drilling, milling or grinding is done using precision machining, such as by Computer Numerical Control (CNC) milling, grinding or drilling for cutting metal positive mold.

In other embodiments for making dissolving microneedle, the method further comprises applying a vacuum, centrifuge or compressive force to the negative mold to fill the mold with the dissolvable polymer and/or a selected drug. In additional embodiments, by simply adjusting the process step, the various product design can be generated. In further embodiments, the methods above further comprise creating a micro-hole at the microneedle tip of the negative mold. In other embodiments, the plastic material is thermoplastic material including polyethylene, polypropylene and PET and other plastic materials.

In additional embodiments, the dissolvable polymer is a hydrogel, such as a hydrogel comprising sodium carboxymethyl cellulose (SCMC).

In certain embodiments, a selected drug and/or vitamin C is added to the negative mold, such as added to a hydrogel that is applied to the negative mold.

These and other embodiments of the subject invention will readily occur to those of skill in the art in view of the disclosure herein.

### BRIEF DESCRIPTION OF THE DRAWINGS

FIG. 1A is the schematic diagram of positive metal microneedle mold on cylinder.

FIG. 1B is magnified representations of a negative plastic mold from the above process.

FIG. 1C illustrates the micro holes at the tip of microneedle on deformable film.

FIGS. 2A and 2B are the exemplary diagrams of manufacturing process using negative plastic mold; dispensing, filling the mold, drying, applying backing film and cutting.

FIGS. 3A to 3C are the exemplary product design from the above fabrication.

### DETAILED DESCRIPTION OF PREFERRED EMBODIMENTS

The practice of the present invention will employ, unless otherwise indicated, conventional methods of engineering, chemistry, biochemistry, pharmacology and drug delivery, within the skill of the art. Such techniques are explained fully in the literature.

All publications, patents and patent applications cited herein, whether supra or infra, are hereby incorporated by reference in their entirety.

It must be noted that, as used in this specification and the appended claims, the singular forms “a”, “an” and “the” include plural referents unless the content clearly dictates otherwise. Thus, for example, reference to “a protein” includes a mixture of two or more polypeptides, and the like.

<Fabrication of Mold>

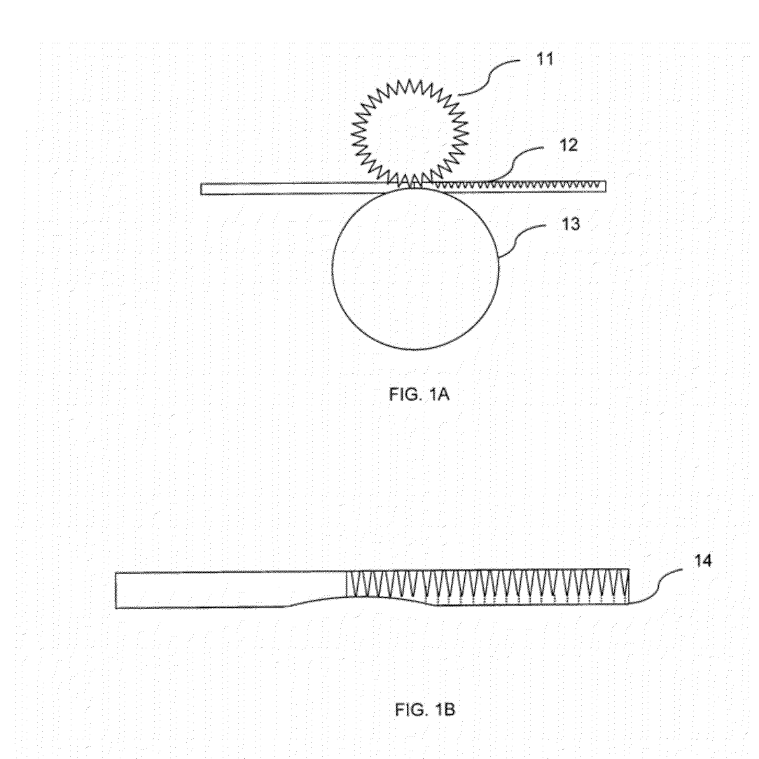

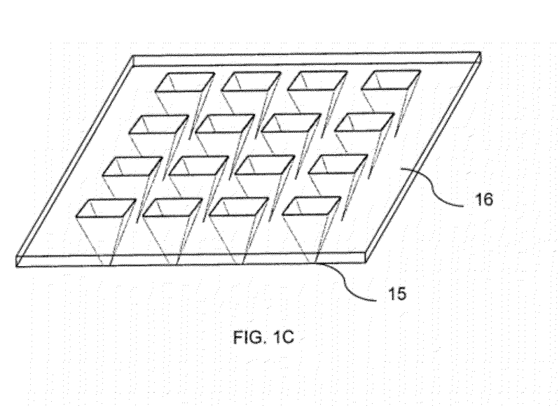

FIGS. 1A-1B show cross-sectional views of positive microneedle array masters on drum 11, for making plastic negative mold 12, supporting cylinder 13.

A fine metal microneedle can be form on the cylinder by cutting or milling or grinding. The pyramid form microneedle is formed form 10-5000 micron length preferred 50-2000 microns. Metal or ceramics are ideal for forming positive microneedle mold because of temperature tolerance result from fabricating process. The various aspect ratio can be designed by how the needle is prepared. For a metal needle, typically wire is ground to the desired sharpness. The needles can have various shapes, such as square cross-section, pentagonal, hexagonal, etc. The distance between needles will vary, depending on application. Typically, needles will be placed at a distance from 5 μm to 5000 μm from each other, such as from 100 to 3000 μm apart, 250 to 1000 μm apart, or any distance within these ranges. The plate can include any number of microneedles, such as 1 to 1,000,000, typically, 10 to 100,000, such as 50 to 10,000, 100 to 1000, or any number within these ranges.

The hydrogel easily fills into the tip of the mold without external pressure, especially when the mold is in a vacuum. For mass production, a external press or vacuum applied to the bottom of the negative mold, or a compressive force that pushes the gel into the microneedle cavity, may be used. As explained above, if a microbubble is trapped during mass production, ventilation provided at the bottom of the microneedle hole in the mold is beneficial. Optionally, the micro-hole or porous plates inside the microneedle cavity can be produced to ventilate the mold and prevent microbubble formation when the negative mold is used for making SSPs. Once the hydrogel is dried, the SSP is separated from the mold and cut for a component of a patch.

A negative plastic mold is made by squeezing positive microneedle on deformable plastic film. Thermoplastic or deformable polymer materials are squeezing between the positive master mold 11, and drum 13, to produce a negative plastic mold 12, having the same surface contour as that of the positive master mold. The plastic can be thermoplastic or elastic or plastic materials. In contact point of two cylinders, the positive microneedle penetrate the plastic film at predetermined distance and when the positive mold is retrieved from the film, that leave micron holes 14, FIG. 1B which can ventilate the micro bubble trapped. In FIG. 1C, the micro holes 15 at the tip of microneedle on deformable film 16 is magnified. Through the micro holes, the microbubble can be easily removed via vacuuming from bottom or applying pressure on the top of microneedle when fabricating.

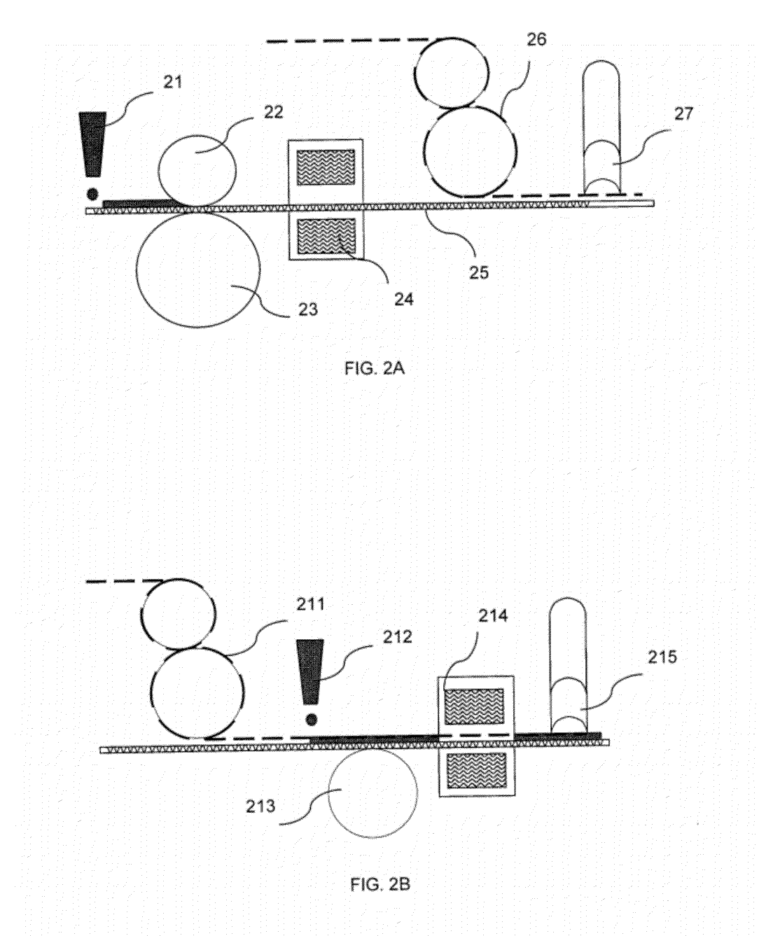

The FIG. 2 are exemplary continuous fabrication line of dissolvable microneedles. In FIG. 2A, the active hydrogel is dispensed from dispenser 21, the gel is filled in the negative plastic micromold between two drums 22 and 23. Optionally the vacuum can be applied via under drum 23. In next step, filled hydrogel is dried in ventilated heater 24, then backing film is laminated on top of the microneedle 26 and in the last stage of the line the patches are cut 27. Another example is depicted in FIG. 2B. Pre-designed baking film 211, is feed to next stage to dispense the hydrogel 212. The dispensed hydrogel is full filled by vacuum from under drum 213 then dried and cut respectively in 214 and 215.

The microneedle array cast can be water soluble and nonsoluble, such as ethylcellulose or water-soluble, such as sodium carboxymethyl cellulose (SCMC). The materials include polycarbonate, polymethyl methacrylate (PMMA), polyvinyl chloride, polyethylene (PE), and polydimethylsilozane (PDMS), and any thermally or chemically or thermoplastic materials.

<Fabrication of SSP>

A liquid solution, including the matrix material and including the selected drug(s) or drug-loaded particles, is cast in the negative mold and dried. Depending on the viscosity and other physical and chemical properties of the liquid solution, additional force such as compression force, vacuum force, or both force may be used to fill the mold with optionally high temperature. To form a solid solution, the solvent can be air-dried, vacuum-dried, freeze-dried, convection oven dried or any other suitable drying method can be used. For continuous mass production, flexible plastic negative mold can be effectively utilized. Referring to FIG. 1C, the cavity tip of the negative mold is open 15 and lined up for continuous production in FIG. 2s. Since the tip is open, a vacuum from the bottom or external pressure from the top can easily fill the cavity with liquid solution. Once fully dried, an inexpensive plastic negative mold or silicone mold can be used as a packaging material. Both the microneedle and mold can be cut and combined until use.

Suitable matrix materials for an SSP perforator include dissolvable polymers, including but not limited to sodium carboxymethyl cellulose (SCMC), sodium hyaluronate (HA), polyvinylpyrolidone (PVP), polyethylene glycol (PEG), polyvinyl alcohol (PVA), polyethylene oxide (PEO), polyacrylic acid, polystylene sulfonate, polypeptide, cellulose, hydroxypropyl cellulose (HPC), hydroxyethyl cellulose (HEC), hydroxypropyl methylcellulose (HPMC), dextrin, dextran, mono- and polysaccharide, polyalcohol, gelatin, gum arabic, alginate, chitosan cylcodextrin, carbohydrate and other water dissolvable natural and synthetic polymer and combinations of the above.

Carbohydrate derivatives, such as sugar derivatives (for example, trehalose, glucose, maltose, lactose, sucrose, maltulose, iso-maltulose, lactulose, fructose, turanose, melitose, mannose, melezitose, dextran, maltodextrin, icodextrin, cyclodextrin, maltotol, sorbitol, xylitol, inositol, palatinit, mannitol, stachyose and raffinose) can be used or mixed with above. Depending on the physical and chemical properties of each component, the mechanical properties and dissolution rate can be designed by using a combination of above.

<SSP>

The SSP perforators can have straight or tapered shafts or can be pyramids as predetermined by the positive master. A desirable penetration depth has a range, rather than a single value, for effective drug delivery and relatively painless and bloodless penetration. Penetration depth of an SSP perforator can affect pain as well as delivery efficiency. In certain embodiments, the perforator penetrates to a depth in the range of 10-1000 μm. In transdermal applications, the “penetrated depth” of the SSP perforator is preferably less than 500 μm so that a perforator, inserted into the skin through the stratum corneum, does not penetrate past the epidermis. This is an optimal approach to avoid contacting nerves and blood vessels. In such applications, the actual length of the SSP perforator can be longer because the basal layer associated with the SSP system may not be fully inserted into the skin because of elasticity and the rough surface of the skin.

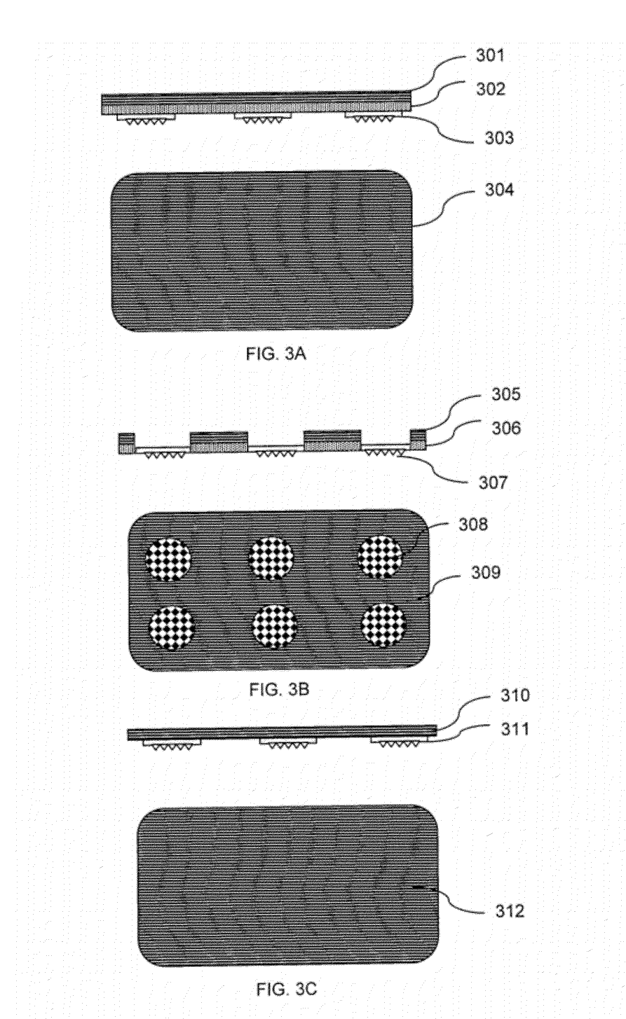

In some cases, concentrating drug at the tip portion of the SSP is desirable. Such an SSP can be designed by a multiple casting/filling method and/or particle concentrating methods as described previously. FIG. 3 show various patch product designs from different fabrication method described in FIG. 2. In FIG. 3A, the patch is composed of backing film 301, adhesive 302 and dried microneedle array 303. The backing film can be porous and occlusive film 304 and the design can provide flexibility and stickiness. The other design is depicted in FIG. 3B which the microneedle is in the spot 308 where no adhesive and no backing film. The backing film 309 in this design can be porous and occlusive type and the patch can be flexible and sticky. Another exemplary patch design is to make microneedle on the backing film directly FIG. 3. The backing film should cover the microneedle array mold prior to drying and backing film should be porous to dry fully. Once the microneedle is dried, the basal layer is on the backing film. The product is flexible but not sticky.

In another embodiment, the flexible and sticky base with the microneedle array can be simply fabricated as described above. For example, SCMC fills the microneedle mold and an adhesive layer is cast and a soft hydrogel formulation are cast sequentially. The resulting patch is a hard microneedle and a sticky/soft basal microneedle array which does not require other adhesive backing film or overlay.

<SSP Patch Systems>

An SSP patch system optionally includes a reservoir containing a liquid or gel form of the second drug and one or more perforators extending from at least a part of the reservoir's surface. The SSP perforators associated with the patch system penetrate the stratum corneum of the skin to enhance percutaneous drug administration and to provide prompt drug delivery. When drug is dispersed in the basal layer, sustained delivery of the drug from the basal layer can be achieved using a backing film. In the patch system, the SSP perforators and the reservoir can be constructed as a single unit or as separate units.

An SSP patch system is applied to the skin so that one or more SSP perforators penetrate through the stratum corneum, into the epidermis or into the dermis depending on the application. In an alternative approach, an SSP and gel, cream and/or lotion are used. For example, the gel can include a drug and/or desired excipients and can be applied or spread at the desired sites. An SSP patch is subsequently inserted. Alternatively, the gel can be applied after patch use.

An SSP system can transport therapeutic and/or prophylactic agents, including drugs and vaccines and other bioactive molecules, across or into skin and other tissues. An SSP device permits drug delivery and access to body fluids across skin or other tissue barriers, with minimal damage, pain and/or irritation at the tissue. In drug delivery applications, an SSP perforator is primarily composed of an active drug (or drug particle itself) and a composition of gel (including cream and lotion) can be designed depending on a desired drug profile. In order to vary or control the drug delivery rate, an external physical enhancement system, using iontophoresis, electrophoresis, sonophoresis, piezoelectric response, a heating element, magnetic element/components, or a similar response or combination of above, can be provided with the overlay layer.

<Drugs to be Delivered by SSP System>

Delivered drugs can be proteins, peptides, nucleotides, DNA, RNA, siRNA, genes, polysaccharides, and synthetic organic and inorganic compounds. Representative agents include, but are not limited to, anti-infectives, hormones, growth regulators, drugs regulating cardiac action or blood flow, and drugs for pain control. The drug can be for vaccination or local treatment or for regional or systemic therapy.

Many drugs can be delivered at a variety of therapeutic rates, controlled by varying a number of design factors including: dimensions of the SSP, drug loading in the SSP, dissolving rate of the matrix, number of SSP perforators, size of the SSP patch, size and composition of the gel (including creams and lotion), and frequency of use of the device, etc. Most applications of SSP drug transdermal delivery target the epidermis, although delivery into blood stream directly is available by extending the penetration length of an SSP patch.

The SSP patch systems disclosed herein are also useful for controlling transport across tissues other than skin. Other non-skin tissues for delivery include nasal or vaginal, buccal, ocular, dental regions or inside a tissue with the aid of a laparoscope or into other accessible mucosal layers to facilitate transport into or across those tissues. For example, an SSP patch can be inserted into a patient's eye to control or correct conjunctiva, sclera, and/or cornea problems, to facilitate delivery of drugs into the eye with a slow moving actuator. The formulated drug stays in the tissue for sustained drug delivery even after the patch is removed. An SSP patch can also be inserted into the oral cavity including buccal membrane for rapid systemic drug delivery or short delivery duration for example breakthrough pain management and for dental treatment applications. A drug may be delivered across the buccal mucosa for local treatment in the mouth or gingiva to act as a muscle relaxant for orthodontic applications.

<Intradermal Drug Delivery Applications>

Another important application is vaccination and for treating and preventing allergies. The skin is an ideal site for effective vaccine delivery because it contains a network of antigen presenting cells, such as Langerhans and dermal dendrite cells. An SSP system for skin immunization can reduce vaccine dose and induce rapid delivery to skin dendrite cell and can provide a depot effect for better vaccination. The SSP system can be easily designed for multivalent vaccines and is expected to provide more stability than the liquid form vaccine in transportation and storage.

Another important use of the subject invention is for cosmeceutical applications. An SSP system with particles can be used efficiently and safely to remove or reduce wrinkle formation, skin aging hyperhidrosis and hair loss. For example, Botulisum toxin (Botox), hydroxyacid, vitamins and vitamin derivatives, Epidermal Growth Factor (EGF), Adenosine, Arbutin, and the like, can be delivered using the systems described herein. The systems are also useful for treating lesions or abnormal skin features, such as pimples, acne, corns, warts, calluses, bunions, actinic keratoses and hard hyperkeratotic skin, which is often found on the face, arms, legs or feet. An SSP system is also useful as a tattoo-creating/removing patch for cosmetic application. Active or sham SSP systems can also be used for acupuncture.

What is claimed is:

1. A method of manufacturing a solid solution perforator patch, comprising:
preparing a positive master mold by a machine cutting microneedles in a plate or a cylinder, wherein the microneedles are cut at a predetermined distance from one another, and tips of the microneedles protrude from a bottom of a defining plate or a cylinder surface;
preparing a negative mold by either squeezing a castable plastic material onto a positive master mold or forcing the positive master mold into a material, to produce the negative mold having the same surface contour as the positive master mold with an open tip;
placing and applying force a dissolvable API hydrogel to the negative mold to form a dissolvable microneedle array; and
drying the microneedle array.

2. The method of claim 1 further comprising applying a vacuum, centrifuge or compressive force to the negative mold to fill the negative mold with at least one of a dissolvable polymer and a selected drug.

3. The method of claim 1 further comprising creating a micro-hole at the microneedle tip of the negative mold.

4. The method of claim 1, wherein the castable plastic material is a thermoplastic material including polyethylene, polypropylene, PET and other plastic materials.

5. The method of claim 2, wherein the dissolvable polymer is a hydrogel.
